(19) United States
(12) Patent Application Publication
(10) Pub. No.: US 2009/0268451 A1
(43) Pub. Date: Oct. 29, 2009

(54) LED LAMP ASSEMBLY

(75) Inventors: SHI-SONG ZHENG, Shenzhen City (CN); LI HE, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/168,912

(22) Filed: Jul. 8, 2008

(30) Foreign Application Priority Data
Apr. 25, 2008 (CN) 200810066684.X

(51) Int. Cl. F21V 1/00; F21V 7/00; F21S 4/00; F21V 29/00

(52) U.S. Cl. 362/235; 362/373; 362/249.02; 362/294

(57) ABSTRACT

An LED lamp assembly includes a bracket and an LED lamp mounted on a side of the bracket. The LED lamp includes an envelope, a first heat sink enclosed by the envelope, a plurality of LED modules mounted on the first heat sink, and a pair of second heat sinks. The second heat sinks are located at outside of the envelope, and abut against opposite ends of the envelope and connect with the first heat sink.

### BACKGROUND OF THE INVENTION

1. Field of the Invention

The present invention relates to an LED lamp assembly, and more particularly to an LED lamp assembly with a heat sink for improving heat dissipation thereof.

2. Description of related art

LED lamps are highly energy efficient electrical light sources, and are increasingly being considered for indoor or outdoor lighting purposes. In order to increase the overall lighting brightness, a plurality of LEDs is often incorporated into a signal lamp, which can lead to significant problems of overheating.

Conventionally, an LED lamp comprises a heat sink, a plurality of LEDs mounted on an outer wall of the heat sink and a transparent envelope covering the heat sink and forming an enclosed housing for the LED lamp. When the LEDs are activated at the same time, a quick rise in temperature of the LED lamp is resulted. Heat generated by the LEDs is accumulated in the enclosed housing formed by the envelope; thus, operation of the LED lamps has a problem of instability because of the rapid buildup of heat. Consequently, the light from the LED lamp often flickers, which degrades the quality of the illumination. Furthermore, the LED lamp is used in a high heat state for a longtime and the life time thereof is consequently shortened.

What is needed, therefore, is an LED lamp which can overcome the above-mentioned disadvantages.

### SUMMARY OF THE INVENTION

An LED lamp assembly includes a bracket and an LED lamp mounted on a side of the bracket. The LED lamp includes an envelope, a first heat sink enclosed by the envelope, a plurality of LED modules mounted on the first heat sink, and a pair of second heat sinks. The second heat sinks are located at outside of the envelope, abut against opposite ends of the envelope and connect with the first heat sink.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled view of an LED lamp assembly in accordance with a preferred embodiment of the present invention.

FIG. 2 is an exploded view of FIG. 1, wherein a reflector of the LED lamp assembly is taken away for clarity.

FIG. 3 is an exploded view of an LED lamp of the LED lamp assembly of FIG. 1.

FIG. 4 is an exploded view of a heat sink assembly of the LED lamp assembly of FIG. 3.

FIG. 5 is an inverted view of FIG. 4.

### DETAILED DESCRIPTION OF THE INVENTION

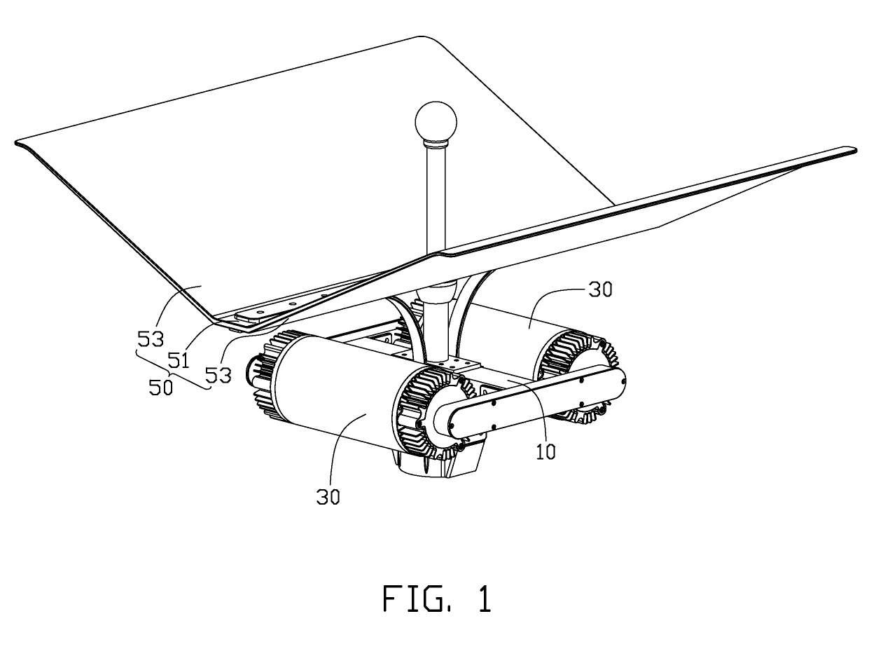

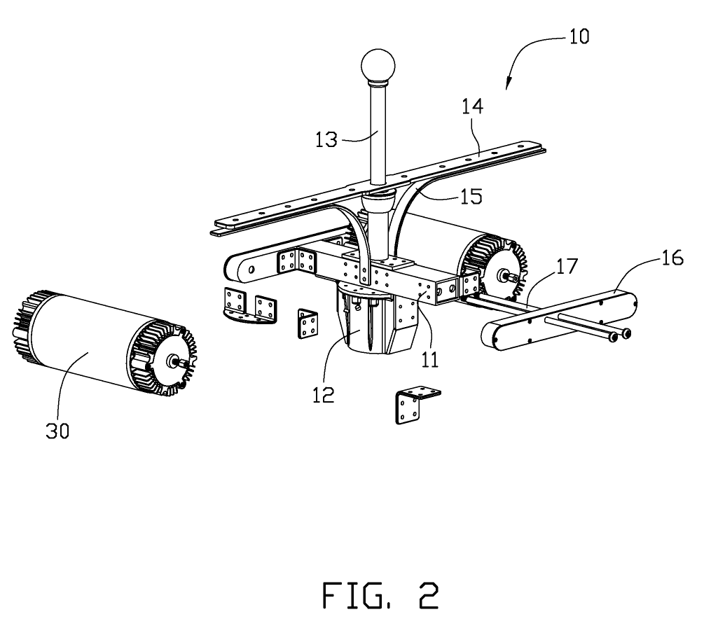

Referring to FIGS. 1-2, an LED lamp assembly for a lighting purpose comprises a bracket 10, a pair of LED lamps 30 mounted on opposite sides of the bracket 10 and parallel to each other, and a reflector 50 secured on the bracket 10 and covering the LED lamps 30 to reflect light emitted from the LED lamps 30.

The reflector 50 has a V-shaped configuration, and comprises an elongated mounting portion 51 and two reflecting portions 53 extending slantwise and outwardly from opposite sides of the mounting portion 51.

The bracket 10 comprises a cuboid connecting portion 11, a fixture 12 secured on a centre of a bottom surface (not labeled) of the connecting portion 11, and a pole 13 secured on a centre of a top surface (not labeled) of the connecting portion 11. The connecting portion 11, the fixture 12 and the pole 13 form a cross shaped configuration. A plurality of angle irons (not labeled) are mounted on the bracket 10 at places where the connecting portion 11, the fixture 12 and the pole 13 are jointed to enhance the stability of the bracket 10. The mounting portion 51 of the reflector 50 snaps the pole 13 of the bracket 10 to mount the reflector 50 on the bracket 10. The mounting portion 51 is spaced from the top surface of the connecting portion 11 of the bracket 10. An elongated pressing plate 14 presses a top surface of the mounting portion 51 of the reflector 50. A pair of arc-shaped reinforcing strips 15 are provided for connecting the connecting portion 11 and the reflector 50. The reinforcing strips 15 each have an end mounted on a centre portion of a corresponding one of two opposite lateral surfaces (not labeled) of the connecting portion 11 of the bracket 10 and another end abutting against a bottom surface (not labeled) of the mounting portion 51 of the reflector 50 in a manner such that the mounting portion 51 of the reflector 50 is sandwiched between the pressing plate 14 and the reinforcing strips 15. Thus, the reflector 50 is securely mounted on the bracket 10. A pair of elongated linkage elements 16 are located at front and rear sides of the connecting portion 11 respectively. A centre portion of each of the linkage elements 16 is connected to an end of the connecting portion 11. Two elongated screws 17 extend through the linkage elements 16, the connecting portion 11 and engage with two nuts (not shown) to mount the linkage elements 16 on the bracket 10. A plurality of reinforcing angle irons (not labeled) are mounted the bracket 10 at places where the connecting portion 11 and the linkage elements 16 are jointed together to enhance the connection strength therebetween. The LED lamps 30 are located at the opposite lateral sides of the connecting portion 11. The two linkage elements 16 are mounted on the front and rear ends of the LED lamps 30 in such a manner that the two LED lamps 30 are sandwiched between the two linkage elements 16.

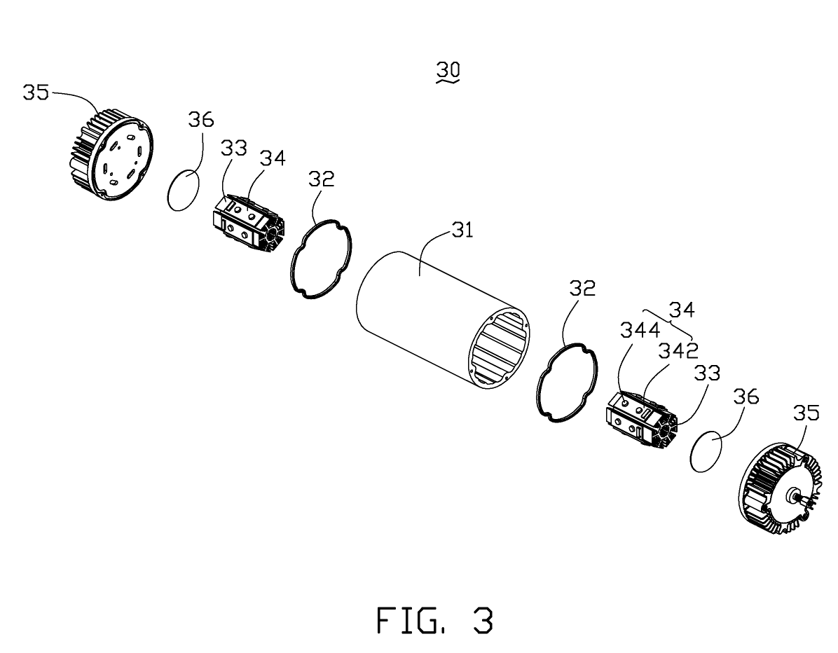

Referring to FIG. 3 also, each of the LED lamps 30 comprises a cylindrical, transparent envelope 31 and a pair of heat sink assemblies (not labeled) symmetrically mounted on the envelope 31. Each heat sink assembly comprises a first heat sink 33 received in an inside of the envelope 31, a plurality of LED modules 34 mounted on the first heat sink 33, and a second heat sink 35 mounted on the first heat sink 33 and located outside of the envelope 31. The first heat sinks 33 of the LED lamp 30 are spaced from each other. Each first heat sink 33 has an outer end (not labeled) coplanar with an end of the envelope 31. The second heat sinks 35 of the LED lamp 30 abut against the outer ends the corresponding first heat sinks 31 and the two opposite front and rear ends of the envelope 31. A pair of gaskets 32 are sandwiched between the envelope 31 and the second heat sinks 35 respectively to provide a waterproof capability at the connections between the second heat sinks 35 and the front and rear ends of the envelope 31. Thermal grease 36 is sandwiched between the first and second heat sinks 33, 35 to enhance heat transferring efficiency of the heat sink assemblies from the first heat sinks 33 to the second heat sinks 35.

Each LED module 34 comprises an elongated printed circuit board 342 and two spaced LEDs 344 mounted on an outer surface of the printed circuit board 342. Each LED module 34 is mounted in a thermally conductive relationship with the first heat sink 33.

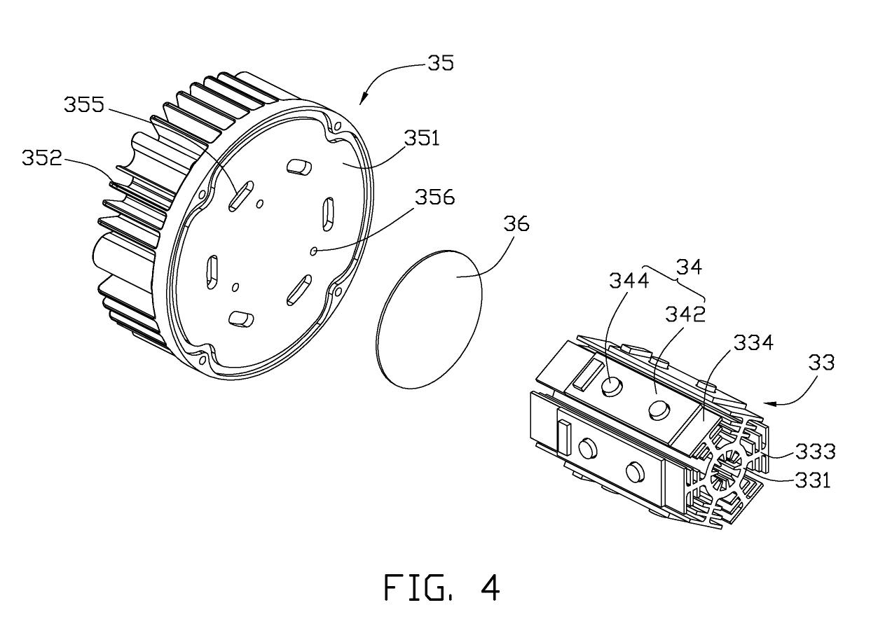

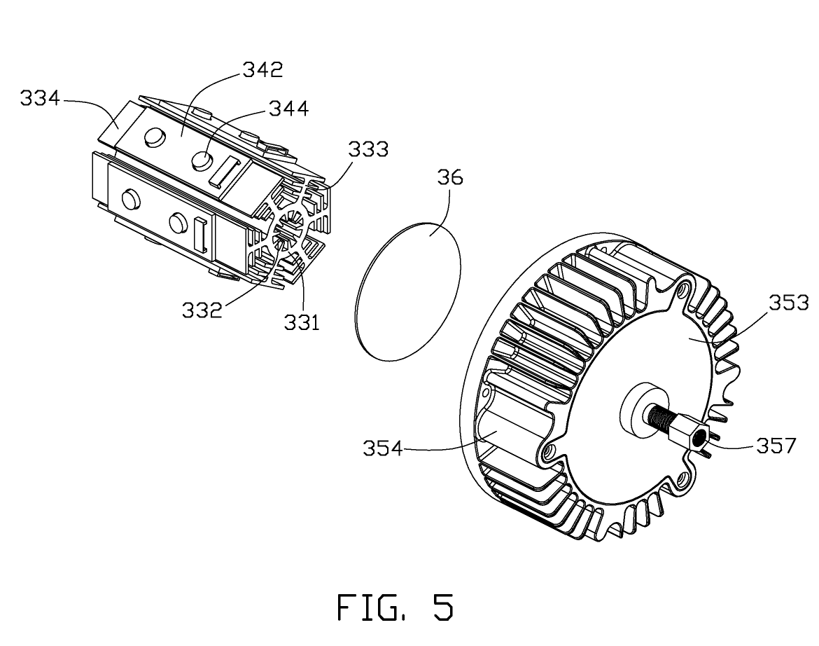

Referring to FIGS. 4-5 also, each first heat sink 33 is integrally formed of a one-piece metal with good heat conductivity, such as aluminum or copper. The first heat sink 33 has a heat conductive member 331 at a centre thereof. In this embodiment, the heat conductive member 331 is an elongated cylinder with a through hole (not labeled) defined therein. The heat conductive member 331 has a plurality of inner fins 332 extending inwardly from an inner wall thereof. The inner fins 332 are centrosymmetrical relative to a central axis of the heat conductive member 331. The first heat sink 33 has a plurality of conducting arms 333 extending radially and outwardly from an outer wall of the heat conductive member 331. The conducting arms 333 are identical to each other and centrosymmetric relative to the central axis of the heat conductive member 331. A quantity of the conducting arms 333 can be different in an alternative embodiment. In this embodiment, the quantity of the conducting arms 333 is designed to be six. Three pairs of outer fins 334 are formed on two opposite lateral sides of each of the conducting arms 333. Each pair of the outer fins 334 extend respectively and perpendicularly from the two opposite lateral sides of the corresponding conducting arm 333 and are symmetrical to each other relative to the corresponding conducting arm 333. Lengths of the outer fins 334 at a lateral side of each of the conducting arms 333 increase along a direction from the conductive member 331 to a distal end of the corresponding conducting arm 333. The distal end of the conducting arm 333 terminates at an inner face of an outermost one of the outer fins 334. An outer face of each outermost outer fin 334 is flat and used for thermally contacting with the LED modules 34. The LED modules 34 are mounted on the outer faces of the outermost outer fins 334 by gluing.

Each of the second heat sinks 35 is made of metal such as aluminum or copper. The second heat sink 35 comprises a disc-shaped coupled portion 351, a hollow, cylindrical receiving portion (not labeled) extending outwardly from a circumference of the coupled portion 351, a plurality of fins 352 extending radially outwardly from a periphery of the receiving portion to dissipate heat thereof, and a cover 353 cooperating with the receiving portion to form a hermetical chamber. A driving circuit module (not shown) is received in the chamber and electronically connects with the LED modules 34 to supply power for the LED lamps 30. A plurality of through holes 355 is defined in the coupled portion 351 for extension of electric wires from the driving circuit module therethorugh to connect with the LED modules 34. Three mounting holes 356 are evenly defined in a center portion of the coupled portion 351 and correspond to three of the conducting arms 333 of the first heat sink 33. Three elongated screws (not shown) extend through the mounting holes 356 and the thermal grease 36 and engage with the three corresponding conducting arms 333 to assemble the first and second heat sinks 33, 35 together. Three protruded portions 354 are equidistantly disposed at the periphery of the receiving portion of the second heat sink 35. Three screws (not shown) extend through of the cover 353 and the protruded portions 354 and engage with the envelope 31 to form the LED lamp 30. In this state, the first heat sinks 33 are received in the envelope 31, and the coupled portions 351 of the second heat sinks 35 abut against opposite end of the envelope 31 to form a hermetical house. A hollow tube 357 is mounted at a centre of the cover 353 and engages with an end of a corresponding linkage elements 16 of the bracket 10 to mount the LED lamp 30 on the bracket 10. The electronic wires extending from the driving circuit module further extends through the tube 357 to electronically connect with a power source. Each of the LED lamps 30 extends along a direction which is perpendicular to an extending direction of the mounting portion 51 of the reflector 50.

When the LEDs 344 emit light, heat generated by the LEDs 344 is absorbed by the first heat sinks 33, then transferred to the second heat sinks 35, and finally dispersed into ambient cool air via the fins 352 of the second heat sinks 35. Therefore, temperature of the hermetical house formed by the second heat sinks 35 and the envelope 31 can be timely lowered. Thus it can be seen that the LED lamps 30 have an improved heat dissipating configuration for preventing the LEDs 344 from overheating. In additional, by the provision of the reflector 50 which covers the LED lamps 30, light emitted from the LED lamps 30 is reflected to orient towards a plurality of different directions, whereby the LED lamp assembly in accordance with the present invention can have a large illumination angle.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp assembly adapted for lighting purpose, the LED lamp assembly comprising:
a bracket; and
an LED lamp mounted on a side of the bracket, the LED lamp comprising an envelope, a first heat sink received in the envelope, a plurality of LED modules mounted on the first heat sink, and a pair of second heat sinks located at outside of the envelope, abutting against opposite ends of the envelope and connecting with the first heat sink.

2. The LED lamp assembly of claim 1, wherein the first heat sink comprises a heat conductive member and a plurality of conducting arms extending radially and outwardly from an outer wall of the heat conductive member, a plurality of outer fins formed on two opposite lateral sides of each of the conducting arms, the LED modules being mounted on outmost outer fins of the first heat sink.

3. The LED lamp assembly of claim 2, wherein the heat conducting member is a cylinder with a through hole defined therein, and the conducting arms are centrosymmetric relative to a central axis of the heat conductive member.

4. The LED lamp assembly of claim 2, wherein each pair of the outer fins extend respectively and perpendicularly from the two opposite lateral sides of a corresponding conducting arm and are symmetrical to each other relative to the corresponding conducting arm.

5. The LED lamp assembly of claim 2, wherein each of the outermost outer fins has a flat outer surface on which a corresponding LED module is mounted.

6. The LED lamp assembly of claim 4, wherein lengths of the outer fins at a lateral side of each of the conducting arms increase along a direction from the conductive member to a distal end of the corresponding conducting arm.

7. The LED lamp assembly of claim 1, wherein each of the second heat sinks comprises a disc-shaped coupled portion connected with one of ends of the first heat sink, a receiving portion extending outwardly from the coupled portion, and a plurality of fins extending radially outwardly from a periphery of the receiving portion.

8. The LED lamp assembly of claim 7, wherein thermal grease is sandwiched between the first heat sink and the second heat sinks.

9. The LED lamp assembly of claim 1 further comprising another LED lamp, the another LED lamp being mounted on another side of the bracket and parallel to the LED lamp.

10. The LED lamp assembly of claim 9, wherein the another LED lamp comprises a second envelope, a first heat sink received in the second envelope, a plurality of LED modules mounted on the first heat sink, and a pair of second heat sinks located at outside of the second envelope, abutting against opposite ends of the second envelope and connecting with the first heat sink.

11. The LED lamp assembly of claim 10, wherein the bracket comprises an elongated connecting portion, the two LED lamps mounted on opposite sides of the connecting portion and parallel to the connecting portion.

12. The LED lamp assembly of claim 1, wherein the bracket comprises a pair of linkage elements mounted on opposite ends of the connecting portion, the two LED lamps being sandwiched between the linkage elements and opposite ends of each of the LED lamps being secured on the linkage elements respectively.

13. The LED lamp assembly of claim 11, wherein the bracket comprises a pole secured on a top surface of the connecting portion, a reflector being mounted on the pole and covering the two LED lamps.

14. The LED lamp assembly of claim 13, wherein the reflector has a V-shaped configuration and comprises an elongated mounting portion and two reflecting portions extending slantwise and outwardly from opposite sides of the mounting portion, the mounting portion snapping the pole of the bracket, the reflecting portions covering the two LED lamps respectively.

15. An LED lamp comprising:a bracket;
a pole extending upwardly from the bracket;
a reflector having an elongated mounting portion at a bottom thereof, the mounting portion being secured with the pole; and
an LED lamp mounted to the bracket and located under the reflector, the LED lamp comprising an envelope, a first heat sink received in the envelop and a second heat sink mounted outside the envelope, the second heat sink being mounted to an end of the envelope and in thermal connection with the first heat sink, and a plurality of LED modules mounted on the first heat sink;
wherein the LED lamp extends along a direction which is perpendicular to an extending direction of the mounting portion of the reflector.
